(19) United States
(12) Patent Application Publication
(10) Pub. No.: US 2024/0247185 A1
(43) Pub. Date: Jul. 25, 2024

(54) IMPROVED METHODS OF CHARGED ELECTROPHORETIC PARTICLE MANUFACTURE

(71) Applicant: HALION DISPLAYS INC., Kitchener (CA)

(72) Inventors: Ryan Phillip Marchewka, Kitchener (CA); Matthew Thomas Lavrisa, Ottawa (CA); Injla Khan, Kitchener (CA); Iamnica Linares, Kitchener (CA)

(21) Appl. No.: 18/290,246

(22) PCT Filed: May 12, 2022
(86) PCT No.: PCT/IB2022/054448

§ 371 Date: Nov. 10, 2023

Related U.S. Application Data
(60) Provisional application No. 63/187,647, filed on May 12, 2021.

(51) Int. Cl. C09K 9/02; C08J 3/12; C08J 7/16; G02F 1/167; G02F 1/1675

(52) U.S. Cl. CPC C09K 9/02; C08J 3/126; C08J 7/16; G02F 1/167; C08J 2300/202; G02F 2001/1678

(57) ABSTRACT

An example charged electrophoretic particle includes a dielectric core structure; and a polymeric corona surrounding the core structure, the polymeric corona comprising: several polymer arms; and a first chemical entity inducible to reversibly switch between a separated state, relative to a second chemical entity, and an optically active state, with the second chemical entity, to change an optical property of the electrophoretic particle in response to the second chemical entity.

### FIELD

The specification relates generally to display devices, and more particularly to electrophoretic display devices.

### BACKGROUND

Various technologies are employed in the manufacture of display panels. Some, e.g. liquid crystal and electrowetting displays, suffer from optical losses, leading to inefficient use of backlight. Others, such as electrochromic displays, suffer from slow response times and increased voltage requirements to drive pixels compared to LCD and electrowetting displays.

### SUMMARY

According to an aspect of the present specification, a charged electrophoretic particle includes a dielectric core structure; and a polymeric corona surrounding the core structure, the polymeric corona comprising: several polymer arms; and a first chemical entity inducible to reversibly switch between a separated state, relative to a second chemical entity, and an optically active state, with the second chemical entity, to change an optical property of the electrophoretic particle in response to the second chemical entity.

According to another aspect of the present specification, a method of forming a charged electrophoretic particle includes: forming an uncharged core structure; charging the core structure; and adding an uncharged polymeric corona to the charged core structure, the polymeric corona including several polymer arms and a first chemical entity inducible to reversibly switch between a separated state, relative to a second chemical entity, and an optically active state, with the second chemical entity, to change an optical property of the electrophoretic particle in response to the second chemical entity.

According to another aspect of the present specification, another method of forming a charged electrophoretic particle, the method comprising: forming an uncharged core structure; and adding a charged polymeric corona to the uncharged core structure, the charged polymeric corona including several polymer arms and a first chemical entity inducible to reversibly switch between a separated state, relative to a second chemical entity, and an optically active state, with the second chemical entity, to change an optical property of the electrophoretic particle in response to the second chemical entity.

According to another aspect of the present specification, another method of forming a charged electrophoretic particle, the method comprising: forming a charged dendrimer core; and adding an uncharged polymeric corona to the charged core structure, the polymeric corona including several polymer arms and a first chemical entity inducible to reversibly switch between a separated state, relative to a second chemical entity, and an optically active state, with the second chemical entity, to change an optical property of the electrophoretic particle in response to the second chemical entity.

### DETAILED DESCRIPTION

Emissive displays display images by producing typically red, green and blue light in a spatially arranged way so as to evoke the sensation of seeing a whole image. There are a wide range of ways in which this is achieved, but typically follow one of two strategies. In the first strategy, the device starts with light emitted uniformly across the surface of the display from a backlighting system of some sort, and then some or all wavelengths are selectively removed. In the second strategy, the light is produced only at the location on the screen where the viewer will see that light. The second strategy is more power efficient since in the first case, the absorbed light is converted to waste heat, whereas in the second case, there is little or no light intentionally wasted.

Emissive displays have two primary drawbacks. The first is that they must shine at least as brightly as their environment in order to achieve good contrast. Since the human eye adjusts to the lighting conditions it's in after an adjustment period, a display seen in the lighting of a building with no brightness adjustment appears nearly impossible to see when viewed outdoors on a sunny day. The light coming from other objects in the environment is much more intense and causes the eye to become less sensitive to light. The display must increase its brightness significantly in order to achieve suitable contrast for the viewer. The second problem is that because the display is constantly producing light, it needs to constantly draw power to produce that light. Other problems involve the mismatch of the display's brightness to the environment's brightness which can lead to eye fatigue, and excessive brightness at night can also lead to insomnia.

Reflective displays hold the promise of solving these problems. These displays do not require the ability to produce light themselves, but instead make use of light already in the environment reflecting off of them. Reflective displays selectively change which wavelengths of light are able to reflect off of them or pass through them, and in what proportion. By varying which colors are absorbed or reflected on different parts of the display and updating these areas periodically, varying information can be displayed to the user. Existing reflective displays have suffered from a number of other issues. These primarily include slow refresh rates in which the display cannot display smooth-looking video, low reflectance in which the display looks grey and faded under all but the brightest environments, and a small color gamut.

The above problems may be avoided by using an electrophoretic media; a detailed discussion of the electrophoretic media is provided in PCT application no. PCT/IB2019/058306 filed Sep. 30, 2019, the contents of which is incorporated herein by reference. In brief, the electrophoretic media (alternately referred to herein as an electrophoretic dispersion) allows light to be selectively absorbed by display elements by bringing into contact two component chemical entities. When these entities form a molecular complex, the optical properties of the complex is different than the optical properties of the separated components. An electrophoretic dispersion where one particle type carries one of the components and another particle type carries the other, and in which the two particle types carry an opposite electrical charge may achieve this purpose. When no electric field is applied, the particles are attracted to one another by electrostatic interactions, causing the component chemical entities to come into contact, and changing the macroscopic optical characteristics of the dispersion. When an electric field is applied, the oppositely charged particles are pulled apart, the complexes that formed are split into the component chemical entities, and the optical properties of the dispersion match that of the separated entities.

An aspect of the present invention is to provide improvements to the charged particles which comprise the electrophoretic media, and methods of manufacture thereof. According to a first aspect of the present invention, the improved charged particles may be produced via emulsion, suspension or dispersion polymerization techniques, making them easier to produce and their properties are easier to control than those described in the above-mentioned PCT application.

According to another aspect of the present invention, the improved charged particles may be produced by an organic synthetic method, resulting in charged particles with a very narrow size and charge distribution.

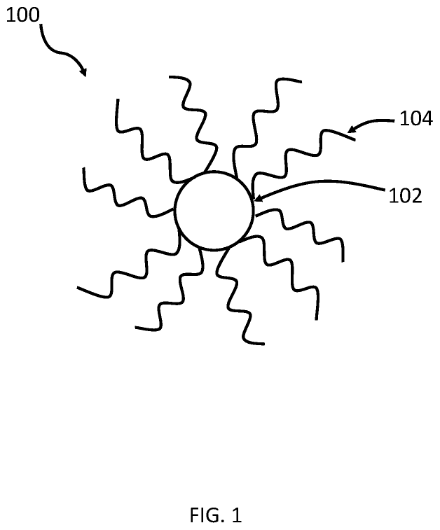

Turning to FIG. 1, a charged electrophoretic particle 100 is depicted. The charged electrophoretic particle 100 comprises a core structure 102, and several polymer arms 104 extending from the surface of the core structure 102. These several polymer arms 104 form a polymeric corona around the core structure 102. The core structure 102 may be a polymeric particle, which in some examples may be crosslinked polymer, or any other particle which permits several polymeric arms to extend from its surface, for example it may be made of another dielectric material such as silica. The polymer arms 104 may be made of a single repeating monomer unit or may comprise two or more monomer units. In some examples, a functionalization strategy may be used wherein at least one of the monomer units comprising the polymer arms 104 may have at least one reactive functional group which is pendant to the polymer backbone, such that additional molecules may be linked to the polymer arms 104 after the particles have been produced, as described in the above-mentioned PCT application. In other examples, a functionalization strategy may be used wherein the polymer arms 104 may be functionalized with the additional molecules before either being induced to form the charged electrophoretic particle 100, or before being grafted onto the surface of the core structure 102 as described in the above-mentioned PCT application. In yet other examples, a functionalization strategy may be used wherein the polymer arms 104 may be polymerized using at least one monomer which may be linked to the additional molecules prior to polymerization, as described in the above-mentioned PCT application. In the examples provided below, the functionalization of the charged electrophoretic particles 100 is not described for simplicity. However, one or more of these above-mentioned functionalization strategies may be applied during or following the production of the particles to link additional molecules to the polymer arms.

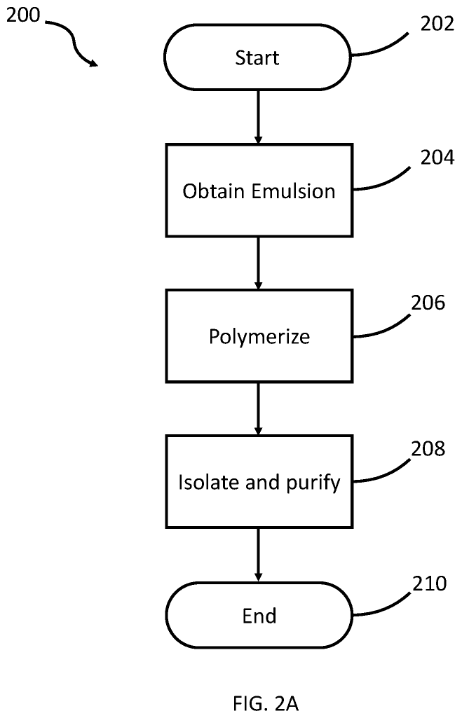

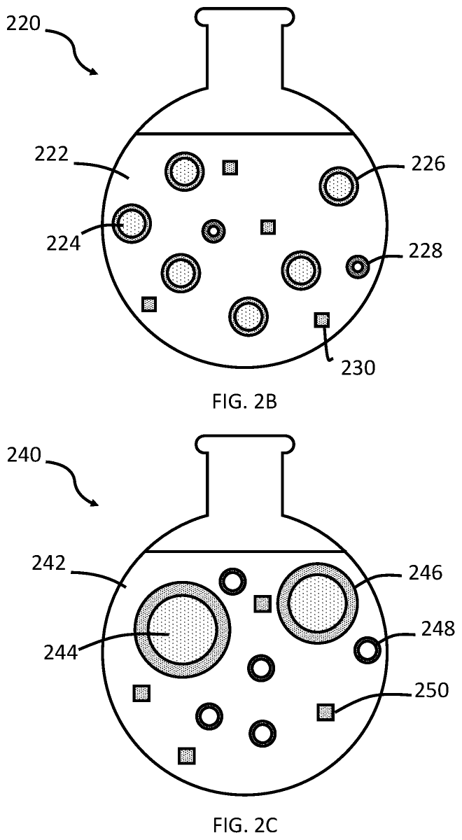

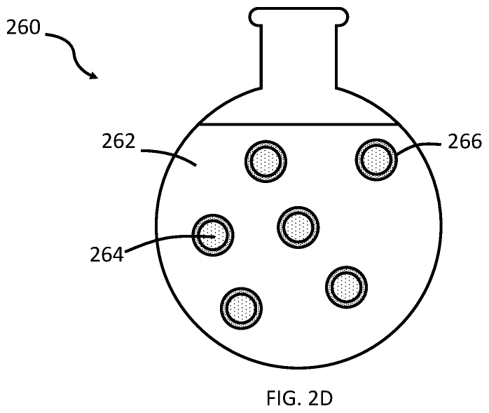

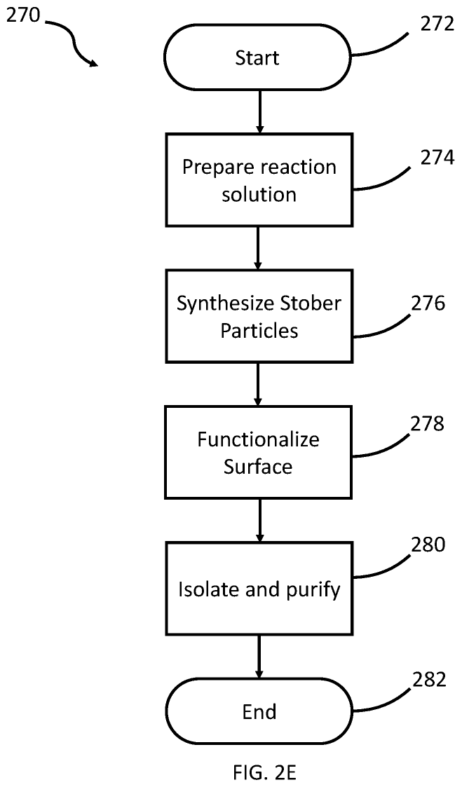

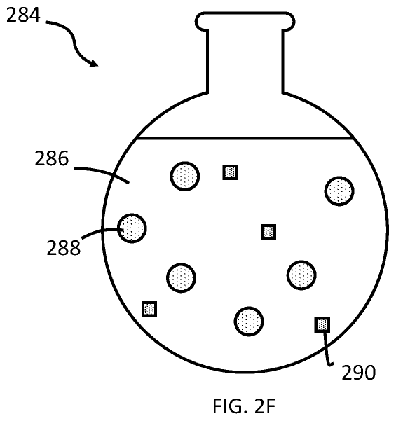

Turning to FIG. 2A, an example method 200 is for producing an uncharged core structure as mentioned above from a polymerization process in an emulsion is provided. In particular, the method 200 may apply a microemulsion polymerization and/or an emulsion polymerization technique to produce the uncharged core. At block 202 the method is started. At block 204, an emulsion is obtained by one of several methods to be described in detail below, the emulsion comprising a continuous phase, at least one monomer with limited solubility in the continuous phase, at least one surfactants which stabilize the emulsion. The emulsion may also comprise additional polymerization mediator compounds, polymerization initiator compounds, charging compounds, cosolvents, plasticizers, crosslinking agents, and the like.

At block 206, the polymerization of the emulsion obtained in block 204 is carried out. This may entail four substeps familiar to those skilled in the art. The first such step may be a purging step, in which oxygen and other quenching species which hamper polymerization are diluted or removed from the reaction vessel. The second step may be an initiation step, in which the polymerization process is initiated. This may occur by a number of mechanisms, for example by heating of thermal initiator compounds within the emulsion, irradiation of photoinitiator compounds within the emulsion, irradiation of the emulsion by an ionizing radiation source such as gamma rays, adding an initiator compound to the emulsion which may readily decompose to produce radical species or which may react with existing emulsion components to form such radical species, or others. The third step may be a polymerization step in which the reaction vessel is allowed to sit under reaction conditions for a time until a desired conversion of monomer to polymer has been achieved. This may entail substantially sealing the reaction vessel against gas exchange or continued purging of the reaction vessel by an inert gas. This may also entail the continuous initiation or re-initiation of polymer chains by the application of heat, radiation, or other means. The final step may be the conclusion of the polymerization reaction, which may take place by stopping the decomposition of initiator compounds, for example by cooling the emulsion or by ceasing irradiation of the emulsion, or in some examples by the introduction of air into the reaction vessel, which may quench the reaction.

At block 208, the resulting polymer particles may be isolated and purified, to concentrate the particles and remove those which do not meet the required specifications. This may be achieved by centrifugation and washing steps, by filtration, by free-flow electrophoresis, by precipitation in other solvents, or by other means.

FIG. 2B depicts an example of the performance of block 204, wherein a reaction vessel containing a microemulsion 220 is provided. Such a microemulsion may undergo a procedure referred to as microemulsion polymerization in the performance of block 206. The microemulsion 220 comprises continuous phase 222. In some examples the continuous phase may comprise at least one polar solvent such as water or dimethyl sulfoxide. Continuous phase 222 may also include one or more additional polar solvents. In some examples, the additional polar solvents may act as cosurfactants in in the stabilization of microemulsion 220 such as short chain alcohols. If continuous phase 222 is a polar solvent, dispersed phase 224 is nonpolar. In other examples, the continuous phase may be a nonpolar solvent and the dispersed phase may be polar. Dispersed phase 224 is thermodynamically stabilized in a microemulsion 220 by the addition of a stabilizer compound 226, such as one or more surfactants. The stabilizer compound 226 may not be entirely consumed in stabilizing the disperse phase 224, but some portion of it may be dissolved, while still other portions may form micelles 228 in solution. In the present example, a polymerization initiator 230 may be present in the continuous phase 222.

In some examples, dispersed phase 224 may comprise monomers which may have vinyl functional groups susceptible to free radical polymerization, for example acrylates, methacrylates, styrenes, acrylamides, vinyl ethers, vinyl halides or others, or other monomers which may have strained ring groups susceptible to ring opening polymerizations such as epoxides. In some examples, dispersed phase 224 may comprise crosslinking agents, such as monomers which have at least two vinyl groups, for example dimethacrylates such as ethylene glycol dimethacrylate, or for example divinylbenzene derivatives, or for example dithiols, or for example having at least two epoxide or other strained ring groups, or monomers which have at least two of two or more of the above functional groups. In other examples where the polymerization proceeds via ring opening reactions, the crosslinker may be a compound which presents at least two nucleophilic groups, or at least two groups which may undergo ring opening polymerization reactions, although in some instances ring opening reactions may be self-crosslinking.

As the polymerization reaction takes place, radicals, monomer, crosslinker, surfactant and even oligomers may be transferred between growing centers, so that by the end of the polymerization phase, substantially all of the surfactant has been used to stabilize the growing centers which may be substantially homogeneous in their size.

In some examples, the microemulsion polymerization may be performed using an atom transfer radical polymerization (referred to as ATRP) method, in which growing polymer chains are rendered temporarily dormant by bromine radicals, but may be reactivated by a transition metal complex which may be oxidized by a released bromine radical. The transition metal complex may be solvated in the dispersed phase by appropriate ligands. For example in nonpolar dispersed phase such as a mixture of butyl methacrylate and ethylene glycol dimethacrylate, the transition metal complex Copper (I) Bromide may be solvated in a nonpolar dispersed phase such as butyl methacrylate by the ligand 4,4′-Dinonyl-2,2′-dipyridyl.

FIG. 2C depicts another example of the performance of block 204, wherein a reaction vessel containing an emulsion 240 is provided. Such an emulsion 240 may undergo a procedure referred to as emulsion polymerization in the performance of block 206. The emulsion 240 comprises continuous phase 242. In some examples the continuous phase may comprise at least one polar solvent such as water or dimethyl sulfoxide. Continuous phase 242 may also include one or more additional polar solvents. In some examples, the additional polar solvents may act as cosurfactants in the stabilization of emulsion 240 such as short chain alcohols. If continuous phase 242 is a polar solvent, dispersed phase 244 is nonpolar. In other examples, the continuous phase may be a nonpolar solvent and the dispersed phase may be polar. Dispersed phase 244 is kinetically stabilized in an emulsion by the addition of a stabilizer compound 246, such as one or more surfactants. The stabilizer compound 246 may not be entirely consumed in stabilizing the disperse phase 244, but some portion of it may be dissolved, while a substantial portion of the stabilizer compound 246 may form micelles 248 in solution. In the present example, a polymerization initiator 250 may be present in the continuous phase 242.

In some examples, dispersed phase 244 may comprise monomers which may have vinyl functional groups susceptible to free radical polymerization, for example acrylates, methacrylates, styrenes, acrylamides, vinyl ethers, vinyl halides or others, or other monomers which may have strained ring groups susceptible to ring opening polymerizations such as epoxides. In some examples, dispersed phase 244 may comprise crosslinking agents, such as monomers which have at least two vinyl groups, for example dimethacrylates such as ethylene glycol dimethacrylate, or for example divinylbenzene derivatives, or for example dithiols, or for example having at least two epoxide or other strained ring groups, or monomers which have at least two of two or more of the above functional groups. In other examples where the polymerization proceeds via ring opening reactions, the crosslinker may be a compound which presents at least two nucleophilic groups, or at least two groups which may undergo ring opening polymerization reactions, although in some instances ring opening reactions may be self-crosslinking.

In this example, the dispersed phase starts out substantially contained within relatively monomer droplets compared to those obtained within a microemulsion. The molecules making up the dispersed phase may be somewhat soluble in the continuous phase, whereby they may migrate to the micelles to undergo a polymerization process, the micelles being far more numerous than the monomer droplets and therefore containing a substantial fraction of the growing polymer chains.

FIG. 2D depicts another example of the performance of block 204, wherein a reaction vessel containing a miniemulsion 260 is provided. Such a miniemulsion 260 may undergo a procedure referred to as miniemulsion polymerization in the performance of block 206. The miniemulsion 260 comprises continuous phase 262. In some examples the continuous phase may comprise at least one polar solvent such as water or dimethyl sulfoxide. Continuous phase 262 may also include one or more additional polar solvents. In some examples, the additional polar solvents may act as cosurfactants in the stabilization such as short chain alcohols. If continuous phase 262 is a polar solvent, dispersed phase 264 is nonpolar. In other examples, the continuous phase may be a nonpolar solvent and the dispersed phase may be polar. Dispersed phase 264 is kinetically stabilized in a miniemulsion 260 by the addition of a stabilizer compound 266, such as one or more surfactants. The stabilizer compound 266 may not be entirely consumed in stabilizing the disperse phase 264, but some portion of it may be dissolved, while a substantial portion of the stabilizer compound 266 may form micelles in solution. In the present example, a polymerization initiator may be present in the continuous phase 262.

In some examples, dispersed phase 264 may comprise monomers which may have vinyl functional groups susceptible to free radical polymerization, for example acrylates, methacrylates, styrenes, acrylamides, vinyl ethers, vinyl halides or others, or other monomers which may have strained ring groups susceptible to ring opening polymerizations such as epoxides. In some examples, dispersed phase 264 may comprise crosslinking agents, such as monomers which have at least two vinyl groups, for example dimethacrylates such as ethylene glycol dimethacrylate, or for example divinylbenzene derivatives, or for example dithiols, or for example having at least two epoxide or other strained ring groups, or monomers which have at least two of two or more of the above functional groups. In other examples where the polymerization proceeds via ring opening reactions, the crosslinker may be a compound which presents at least two nucleophilic groups, or at least two groups which may undergo ring opening polymerization reactions, although in some instances ring opening reactions may be self-crosslinking.

In this example, the dispersed phase starts out substantially contained within relatively small monomer droplets compared to those obtained within an emulsion. The emulsification process may have been a nanoemulsion formation process, in which the surfactant is dissolved first in the dispersed phase, and the continuous phase was added to this mixture, or may have been through a phase inversion temperature method in which temperature is used to invert the emulsion from a water-in-oil emulsion to an oil-in-water emulsion, or vice versa, or through a physical homogenization process which exerts very high shear on the emulsion, or by some other method. The molecules making up the dispersed phase, especially the initiator, may be substantially insoluble in the continuous phase, whereby they may not easily migrate to other particles. The particles remain substantially the same size throughout the reaction as a result.

Turning to FIG. 2E, an example method 270 is for producing an uncharged core structure as mentioned above from a silica Stober process is provided. At block 272 the method is started. At block 274, a reaction solution is obtained comprising water and a catalyst such as ammonia. The reaction solution may also comprise an alcohol such as ethanol, surfactants, charge control agents, other cosolvents, organic or inorganic salts, or other components which may occur to those skilled in the art.

At block 276, the Stober process is carried out in the reaction solution obtained in block 274. This may entail adding one or more organometallic precursors, such as tetraethyl orthosilicate, tetramethyl orthosilicate, titanium isopropoxide or others to the reaction solution. In some examples this may be done rapidly, in other examples this may be done slowly to keep the reaction conditions mild, which may produce particles with a smaller size dispersity as may be preferable.

At block 278, the resulting ceramic nanoparticles are functionalized. This may include functionalizing with charge-bearing chemical functional groups to give the particles charge. It may also include functionalizing with polymerization mediator or initiator groups, such as those used in controlled radical polymerizations such as atom transfer radical polymerization (ATRP) or reversible addition fragmentation transfer polymerization (RAFT) or others, or ring opening polymerizations, or free radical polymerizations, or any polymerization method which may be carried out from a solid surface and which may make a linear polymer chain. An example performance of block 278 is to disperse the silica particles obtained in the performance of block 276 in an ethanol and dioxane mixture, and under agitation add a silane-based polymerization initiator such as (3-trimethoxysilys)propyl 2-bromo-2-methylpropionate. Allow the dispersion to continue stirring for at least one hour to allow the silane to adsorb to the silica surface. After sufficient time has passed for this to occur, heat the dispersion under reflux for at least one hour to promote the formation of covalent bonds between the silica and the silane.

At block 280, the resulting functionalized particles may be isolated and purified, to remove excess reagents, to concentrate the particles and to remove those which do not meet the required specifications. This may be achieved by centrifugation and washing steps, by filtration, by free-flow electrophoresis, by precipitation in other solvents, or by other means. At block 282 the method is finished.

FIG. 2F depicts an example of the performance of block 276, wherein a reaction vessel 284 containing a reaction solution 286 in which is dispersed growing ceramic nanoparticles 288 and organometallic precursors 290 is provided. In some examples the reaction solution 286 may comprise water. Reaction solution 286 may also include one or more short chain alcohols to control the reaction rate and final size of the obtained ceramic nanoparticles. Reaction solution 286 may also include one or more additional polar solvents. In some examples, the additional polar solvents may act as cosurfactants in in the stabilization of the growing ceramic nanoparticles such as short chain alcohols. The growing ceramic nanoparticles 288 may be stabilized by the addition of a stabilizer compound such as one or more surfactants. The growing ceramic nanoparticles may have their growth catalyzed by one or more catalysts, such as ammonia which may be dissolved in reaction solution 286. Organometallic precursors 290 may be added slowly or rapidly to the reaction vessel 284 to provide material for the growing ceramic nanoparticles, such as tetraethyl orthosilicate, tetramethyl orthosilicate, titanium isopropoxide. The selection of these precursors depends on the desired reaction rate, desired refractive index of the particles, catalyst choice as well as concentration, ratio of water to alcohol, temperature, and other factors.

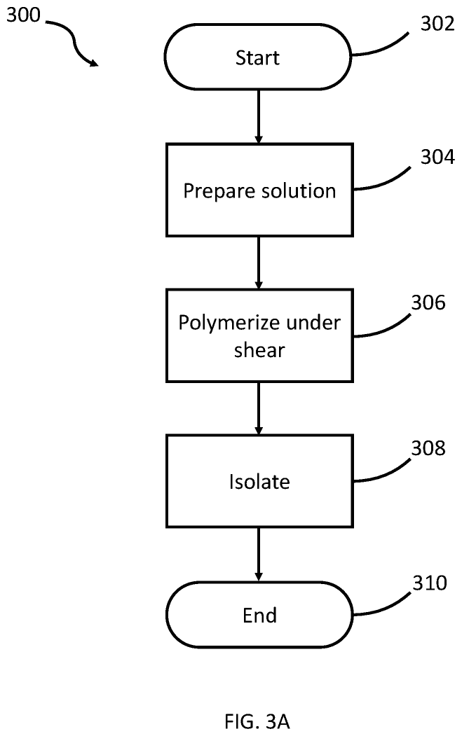

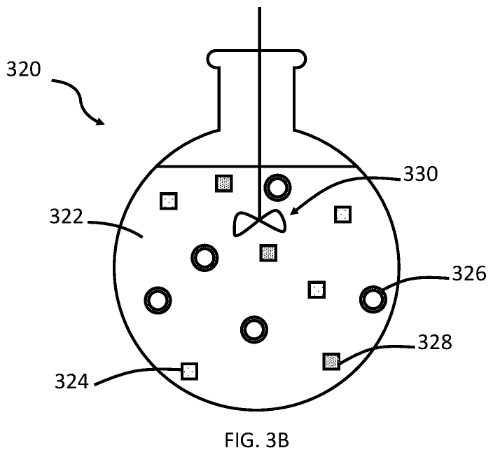

Turning now to FIG. 3A, an example method 300 is for producing an uncharged core structure as mentioned above from a polymerization process in an emulsion is provided. In particular, the method 300 may apply a dispersion polymerization technique. At block 302 the method is begun. At block 304, a solution is obtained comprising a single continuous phase, at least one monomer having solubility in the continuous phase, at least one surfactant which will stabilize the dispersion after the performance of block 306, the polymerization step. The solution may also comprise additional polymerization mediator compounds, polymerization initiator compounds, charging compounds, cosolvents, plasticizers, crosslinking agents, and the like.

At block 306, the polymerization of the solution obtained at block 304 is carried out. This may entail four substeps familiar to those skilled in the art. The first such step may be a purging step, in which oxygen and other quenching species which hamper polymerization are diluted or removed from the reaction vessel. The second step may be an initiation step, in which the polymerization process is initiated. This may occur by a number of mechanisms, for example by heating of thermal initiator compounds within the emulsion, irradiation of photoinitiator compounds within the emulsion, irradiation of the emulsion by an ionizing radiation source such as gamma rays, adding an initiator compound to the emulsion which may readily decompose to produce radical species or which may react with existing emulsion components to form such radical species, or others. The third step may be a polymerization step in which the reaction vessel is allowed to sit under reaction conditions for a time until a desired conversion of monomer to polymer has been achieved. This may entail substantially sealing the reaction vessel against gas exchange or continued purging of the reaction vessel by an inert gas. This may entail the continuous initiation or re-initiation of polymer chains by the application of heat, radiation, or other means. This may also entail the continuous shearing of the dispersion to prevent premature precipitation of the forming polymer. The final step may be the conclusion of the polymerization reaction, which may take place by stopping the decomposition of initiator compounds, for example by cooling the emulsion or by ceasing irradiation of the emulsion, or in some examples by the introduction of air into the reaction vessel, which may quench the reaction.

During the performance of block 306, chains of polymer are obtained in the solution which may be less stable in the solvent system than the monomer, and thus may tend to precipitate from the solution. These chains are stabilized by stabilizer compounds such as surfactants, as well as by continuous shear which may be applied to the dispersion. The chains may aggregate with other chains in solution, forming particles. They may also crosslink with other chains in solution, also forming particles.

At block 308, the resulting polymer particles may be isolated and purified, to concentrate the particles and remove those which do not meet the required specifications. This may be achieved by centrifugation and washing steps, by filtration, by free-flow electrophoresis, by precipitation in other solvents, or by other means.

FIG. 3B depicts an example of the performance of block 304, wherein a reaction vessel containing a solution 320 is provided. Such a solution 320 may undergo a procedure referred to as dispersion polymerization in the performance of block 306. The solution 320 comprises solvent 322. In some examples the solvent 322 may comprise at least one polar solvent such as water or dimethyl sulfoxide. Solvent 322 may also include one or more additional polar solvents. In some examples, the additional polar solvents may act as cosurfactants in stabilization such as short chain alcohols. If solvent 322 is a polar solvent system, monomers 324 is of medium polarity but forms nonpolar polymer chains. In other examples, the continuous phase may be a nonpolar solvent and the monomer may form polar polymers. The solution 320 may also comprise a stabilizer compound 326, such as one or more surfactants. A substantial portion of the stabilizer compound 326 may form micelles (shown), or while some portion of the stabilizer compound 326 may be dissolved in the solution 320 (not shown). A polymerization initiator 328 may also be dissolved in solution 320. In the present example a mechanism for producing shear may be provided such as impeller 330. To reduce gas exchange, impeller 330 may be sealed with a gasket or other device which may prevent gas exchange during the polymerization.

In some examples, monomers 324 may comprise monomers which may have vinyl functional groups susceptible to free radical polymerization, for example acrylates, methacrylates, styrenes, acrylamides, vinyl ethers, vinyl halides or others, or other monomers which may have strained ring groups susceptible to ring opening polymerizations such as epoxides. In some examples, monomers 324 may comprise crosslinking agents, such as monomers which have at least two vinyl groups, for example dimethacrylates such as ethylene glycol dimethacrylate, or for example divinylbenzene derivatives, or for example dithiols, or for example having at least two epoxide or other strained ring groups, or monomers which have at least two of two or more of the above functional groups. In other examples where the polymerization proceeds via ring opening reactions, the crosslinker may be a compound which presents at least two nucleophilic groups, or at least two groups which may undergo ring opening polymerization reactions, although in some instances ring opening reactions may be self-crosslinking.

In this example, the monomers 324 start out substantially dissolved in the solvent 322. The monomers 324 may undergo a polymerization reaction, producing a polymer which is insoluble in the solvent 322, and which may tend to precipitate from the solution 320, were it not for the shear and stabilizer compound 326 which may prevent the precipitation. The polymer chains may instead form particles, especially when they become crosslinked with other polymer chains.

In the above emulsion polymerization-based core structure forming method, the microemulsion polymerization-based core structure forming method, or the dispersion polymerization-based core structure forming method, the polymerization may be carried out in one step as described above, or may include one or more additional a semi-batch steps, in which additional monomer may be added partway through the polymerization reaction to either increase the size of the particles or change the outer polymer layers to other types of polymers. This may be useful especially providing the particles with charge as will be discussed in greater detail below, or for changing the surface functionality of the particle to provide functional groups which may undergo desired chemical reactions, as will also be discussed in greater detail below. For instance the particle may comprise a first spherical layer of crosslinked polybutyl methacrylate and an additional layer of polyhydroxyethyl methacrylate, wherein the alcohol groups present in the latter layer may be used as reactive functional groups which may link to polymer arms as described below, which may be replaced with other reactive groups which may link to polymer arms as described below, or which may be replaced with polymer initiator groups as described below.

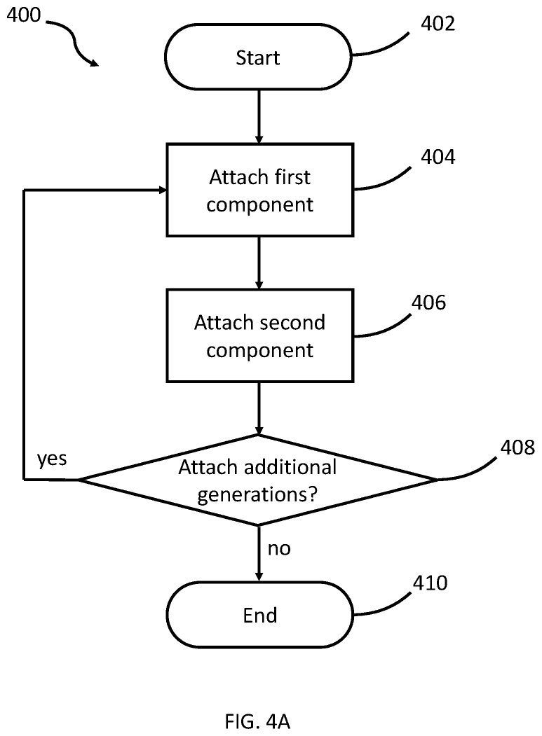

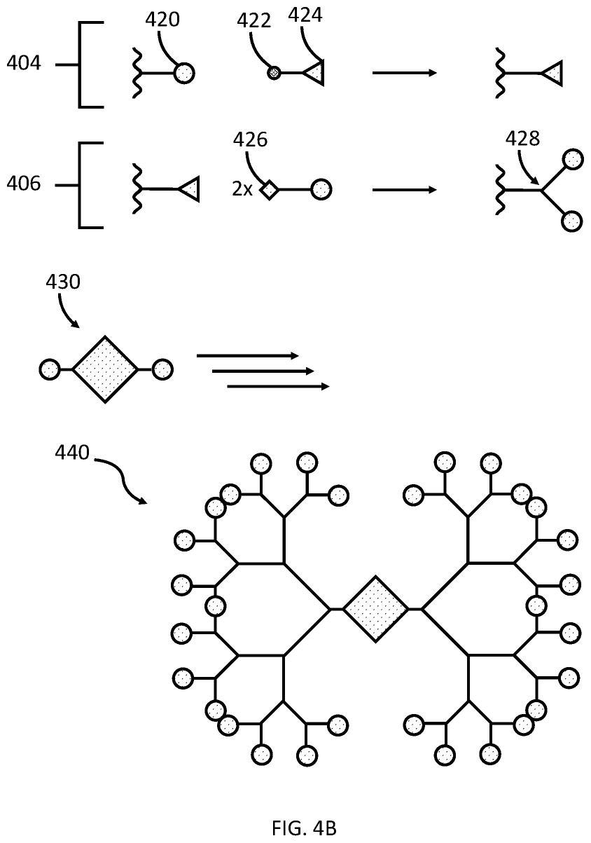

FIG. 4A is a flowchart of an example of another method 400 for producing core structure 102. The method may be referred to as the dendrimer core-forming method. The core structure produced by the method 400 may be charged or uncharged based on the multifunctional synthetic core used to produce the core structure.

At block 402 the method is begun by obtaining a multifunctional synthetic core, which will be discussed in more detail below. The multifunctional synthetic core contains at least one, preferably at least two first linking functional groups off of which to begin the synthesis of a dendrimer particle. At block 404, a first generational component may be attached to the multifunctional synthetic core at all of the above mentioned first linking functional groups. The first generational component has a second linking functional group which is selected to specifically react with the first linking functional group under certain reaction conditions. The first generational component may also have a branching functional group. In some examples, the performance of this block may entail the purification or isolation of the molecule to remove excess reagents.

At block 406, a second generational component may be attached to the molecule at all of the branching groups. The second generational component has a third linking functional group which reacts specifically with the branching functional group under certain reaction conditions. The branching functional group may be able to react with at least two second generational components via the branching functional group, such that for every branching functional group, at least two second generational components is attached to the molecule. The second generational component also bears a first linking functional group. In some examples, the performance of this block may entail the purification or isolation of the molecule to remove excess reagents.

At decision point 408, it is decided whether or not to return to block 404 to add on more generations to the dendrimer molecule. If the answer is yes, return to block 404 and proceed from there. If the answer is no, the method 400 is ended at block 410.

In some examples, the method may be ended after several iterations of blocks 404 and 406.

In some examples the method may be ended after the performance of block 404 instead of block 406, depending on the surface functionality desired for the particle. For example it may be beneficial to have the surface of the particle bearing the branching functional group rather than the first linking functional group.

In some examples the multifunctional synthetic core may present functional groups which react with the third linking functional group, meaning the method skips block 404 at first and performs block 406 at first.

In some examples, the dendrimer grows substantially exponentially in size at each generation because of the branching functional group. In other examples, the dendrimer comprises too many generations and due to steric crowding, some of the linking groups may be blocked from reacting further. Larger generational components may delay this from happening for one or more generations, which may be preferable depending on the size of the particle and linking and branching functional groups selected. Different generational components may be used at different generations to address this problem.

Turning now to FIG. 4B, a schematic diagram of an example performance of the method 400 is depicted. The performance of block 404 is indicated, with a first linking functional group 420 and a second linking functional group 422 reacting, leaving a species which bears the branching functional group 424. The performance of block 406 is indicated, with a third linking functional group 426 reacting the branching functional group 424 twice, leaving a branched structure 428.

Multifunctional synthetic core 430 in this example bears two first functional groups off of which to start the reaction. After performing blocks 404 and 406 each 4 times, the 4^{th} generation dendrimer molecule 440 is obtained. Additional generations may be appended as desired.

Returning to FIG. 4A, in some examples, it may be preferable that dendrimer molecule does not contain ionizable groups outside of its multifunctional synthetic core. There are many known chemistries for growing dendrimer generations (i.e. chemistries for the linking functional groups and the branching groups, as well as the first and second generational components themselves), but it may be preferable that the first and second generational components do not have ionizable groups, such as carboxylic acids, amines, quaternary ammonium groups, organophosphates, or other groups which may ionize in neutral water or other solvents. It may further be preferable that the linkages formed by the reaction of the first and second linking functional groups and the reaction of the branching and third linking functional groups do not yield moieties which may ionize in neutral water or other solvents. An example of a suitable choice for the first and second generational components include 1-thioglycerol and acrylic acid. The thiol group reacts with the vinyl group forming a thioether which does not ionize readily. The alcohols each react with the carboxylic acid, producing esters which also do not ionize readily. Several other examples fitting these criteria exist, including examples which use the same combinations of reactive functional groups but have different moieties in between them.

In some examples, after the method 400 is ended, the dendrimer molecule may be purified and/or isolated and may undergo further processing. In some examples, the further processing may include surface functionalization of the particles. This may be to promote chemical linking, polymerization from the surface, or to impart charge to the surface of the dendrimer molecule, as will be discussed below.

In some examples, method 400 may be the preferred method for producing the core structure 102, as the size dispersity of the produced particles will be extremely low, approaching 1, which may be beneficial in some applications.

Other methods to obtain the core structure 102 as described above are contemplated, for example via a suspension polymerization process, by the Stober particle growth process producing silica particles, or by other methods. Methods 200, 270, 300 and 400 are simple to perform, may result in a high final yield of particles, may give particles of a substantially uniform size distribution, may be flexibly changed to produce core structures of different sizes, and may be easily scaled to higher volume production.

Turning now from the formation of the core structure 102 to the polymeric arms 104 discussed above, methods to obtain the same are provided.

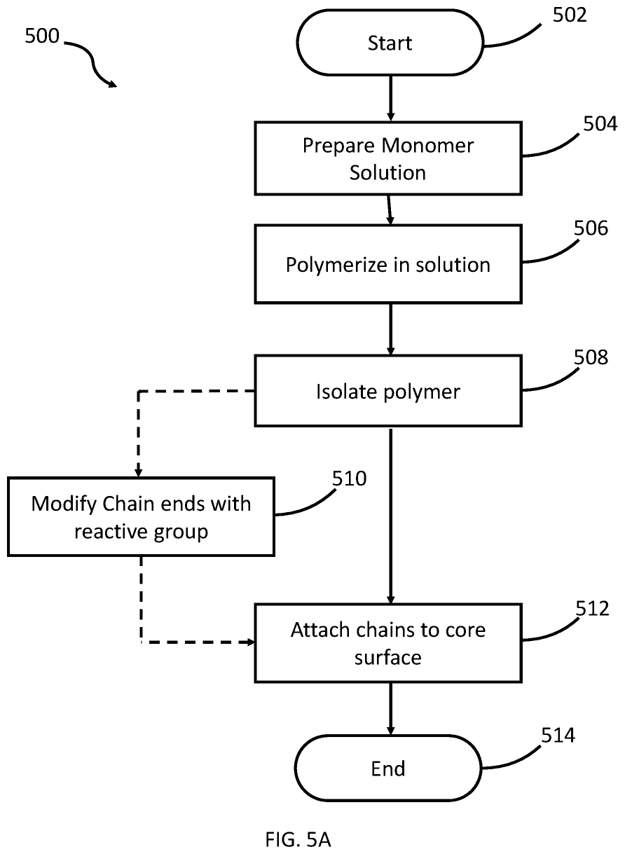

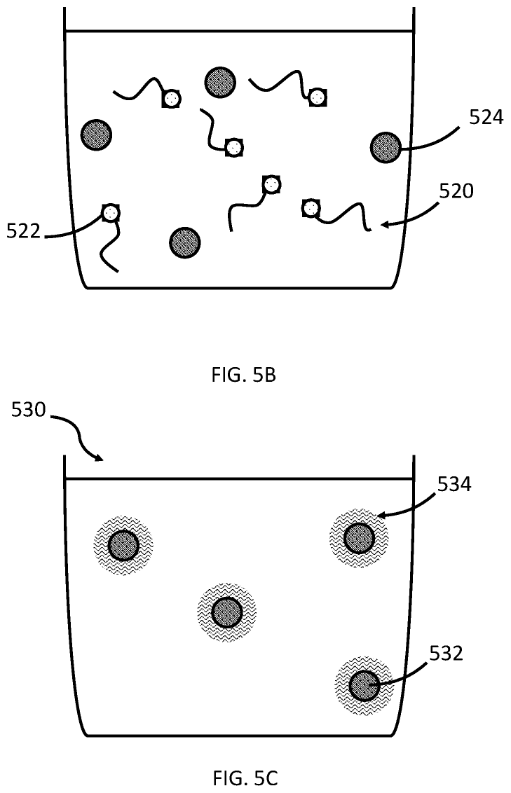

FIG. 5A depicts a flowchart of an example method 500 for adding an uncharged polymeric corona including polymeric arms 104 to a core structure. Since the polymeric arms 104 obtained via the method 500 are uncharged, the core structure to which the method 500 is applied may preferably be a charged core structure. The method 500 begins at block 502. At block 504, a monomer solution is prepared, whereby at least one monomer, at least one initiator, at least one solvent as well as other polymerization mediators are combined in a solution. Monomers may be selected to promote the solubility of the final particle 100 in the target solvent in which it is to be dissolved. For example, if the particle 100 is to be dissolved in water or DMSO, a monomer such as acrylamide or glycidyl monomethacrylate may be chosen. The solution is polymerized at block 506 by one of several types of polymerization. For example, the polymerization may be an ATRP polymerization, in which a metal complex such as copper (I) bromide may be provided as well as ligands such as Tris(2-dimethylaminoethyl)amine are provided, as well as an ATRP initiator such as ethyl-2-bromoisobutyrate. Other examples include reversible-addition-fragmentation polymerization, ring-opening polymerization, nitroxide mediated polymerization, free radical polymerization, and other methods which produce substantially linear polymer chains.

In some examples, the linear polymer chains may be block copolymers or gradient copolymers comprising at least two monomers to improve the solubility or other properties of the linear polymer chains. The growth of block copolymers may require an additional isolation step to ensure that the monomer from the first block is completely removed from solution before growing the next block.

At block 508, the produced linear polymer is isolated, whether by precipitation in a nonsolvent or other method.

Block 510 is an optional step in which the ends of the obtained linear polymer are modified with a reactive group that permit chemical linking to other reactive groups. Depending on the polymerization method used, this step may be superfluous. For example, if the polymerization method chosen was a variety of ATRP, an ATRP initiator may have been selected which already presented a reactive functional group, such as in the case of 2-Azidoethyl 2-bromoisobutyrate or 3-Butynyl 2-bromoisobutyrate for example. The performance of block 510 for example may entail positioning a strong nucleophile or electrophile on either end of the linear polymer using whichever reactive groups are known to be present on them. It may also entail positioning some other terminal coupling agent which may be used in an organometallic coupling reaction.

At block 512, the obtained linear polymer may be attached to the surface of the core structure 102.

The core structure 102 may be formed by any of the above mechanisms. As described above, the core structure 102 may comprise a polymer or other dielectric material, or an outer polymer layer which has reactive functional groups present on the surface. These functional groups may be used as provided to link to functional groups on the linear polymer obtained at block 506. In other examples they may be used to link to another compound which presents a linking group which is specifically chosen to be linked to the group provided at the end of the linear polymer.

FIG. 5B depicts the performance of block 512, in which the linear polymers 520 with reactive end groups 522 and functionalized core structures 524 are present in solution together. In some examples, the reactive groups may immediately react with one another, for example as in the example of an acyl chloride functionalization and an alcohol. In other examples, the reactive groups may require additional reagents or reaction conditions to proceed, such as the application of heat, the addition of an organometallic coupling catalyst, the addition of an acid or a base, or other conditions or reagents.

FIG. 5C depicts the produced electrophoretic particles 530 after the performance of block 512, comprising core structure 532 and polymeric corona 534 which further comprises the grafted linear polymer chains. The produced electrophoretic particles may undergo further processing as described in the above-mentioned PCT application.

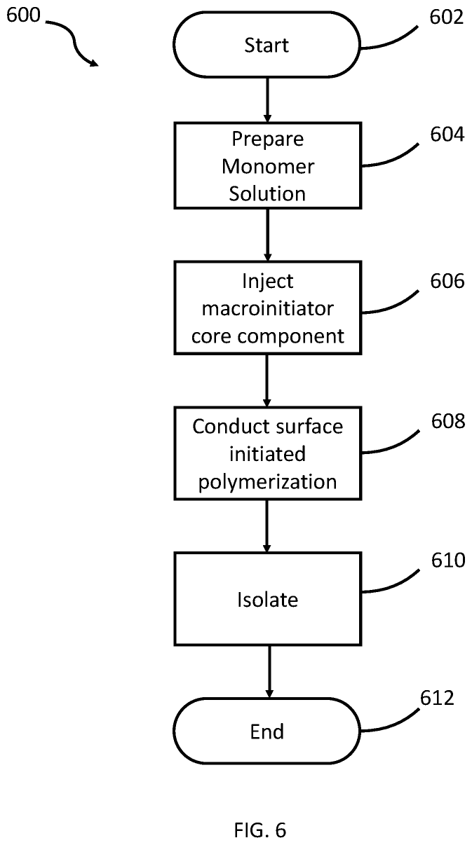

FIG. 6 depicts a flowchart of an example method 600 which may be used to add an uncharged polymeric corona including polymeric arms 104 to a core structure. Since the polymeric arms 104 obtained via the method 600 are uncharged, the core structure to which the method 600 is applied may preferably be a charged core structure. The method begins at block 602.

At block 604, a monomer solution is prepared which may comprise monomer, solvent, initiator, as well as polymerization mediators. Monomers may be selected to promote the solubility of the final particle 100 in the target solvent in which it is to be dissolved. For example, if the particle 100 is to be dissolved in water or DMSO, a monomer such as acrylamide or glycidyl monomethacrylate may be chosen.

At block 606, macroinitiator core structures are added to the monomer solution. These macroinitiator core structures may have been modified with functional groups or other moieties present on their surfaces which may be able to initiate a polymerization. For example, a core structure with hydroxyl groups such as on a silica sphere, or a polymeric sphere which presents hydroxyl groups on the surface on the surface may be modified with a reagent such as 2-Bromo-2-methylpropionyl bromide, which reacts with the alcohol, leaving an ATRP initiator on the surface. Other reactions are contemplated which functionalize the core structure surface with suitable moieties to be used in other types of polymerization for example nitroxide mediated polymerization or reversible addition fragmentation transfer polymerization.

At block 608, the functionality on the surface of the macroinitiator core structures and the monomer solution participate in a polymerization reaction, in which linear polymer chains are grown from the surface of the macroinitiator core structure. These form the polymer arms 104, akin to the polymer arms which made up the polymeric corona 534 discussed above. This method may be preferable in some examples to achieve higher grafting densities of polymer arms on the surfaces of the core structures.

In other examples, the core may have been formed with a polymerization mechanism matching the method which is to be used to grow the polymeric arms. For example, an ATRP mediated microemulsion polymerization may have been carried out with a high concentration of ATRP initiators. As the polymerization proceeds, these initiators may still find themselves present on or near the surface of the core structure after polymerization has ceased. If they are sufficiently close to the surface, within a narrow diffusion layer, these polymer chain ends may be re-initiated in a new ATRP reaction which then proceeds to grow the polymer arm 104 from the surface of the particle.

In some examples, the grown polymer arms may be block copolymers or gradient copolymers comprising at least two monomers to improve the solubility or other properties of the grown polymer arms. The growth of block copolymers may require an additional isolation step to ensure that the monomer from the first block is completely removed from solution before growing the next block.

At block 610 the particles are isolated and purified, to concentrate the particles and remove those which do not meet the required specifications. This may be achieved by centrifugation and washing steps, by filtration, by free-flow electrophoresis, by precipitation in other solvents, or by other means.

Methods 500 and 600 may be simple to perform, may result in a high final yield of particles, may give particles of a substantially uniform size distribution, may be flexibly changed to produce polymeric coronae of different sizes, and may be easily scaled to higher volume production.

The core structure 102 and polymer arms 104 of the charged electrophoretic particles 100 have so far been discussed. Now turning to the methods by which the particles obtain their charge.

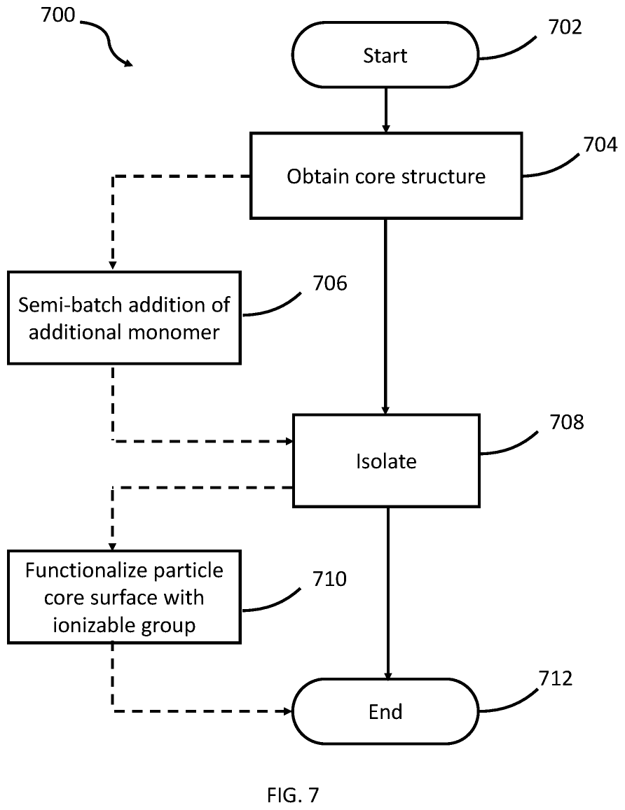

FIG. 7 is a flowchart of an example method 700 of obtaining charged cores. Specifically, the method 700 may be applied to an uncharged core structure to charge the core structure. The method 700 begins at block 702.

At block 704, a core structure is obtained. In particular, an emulsion polymerization-based core-forming method, a microemulsion polymerization-based core-forming method, or a dispersion polymerization-based core-forming method is performed. For example, the methods 200 or 300 may be performed to form the core structure. In some examples, another method, such as the Stober process method 270 or the dendrimer method 400 may be performed in place of block 704. In such examples, block 706 may not be performed.

In some examples, the core structure at block 704 is produced using uncharged monomers, surfactants, and initiators. In such examples, block 706 may also be performed, in which partway through the polymerization process, an additional injection of charge imparting moieties may be made. For example, additional monomers may be injected, where the additional monomers may comprise one or more ionizable monomers. The additional monomers may be selected appropriately to give the particles the desired charge sign. For example, the additional monomer may possess a sulfonate group in an example where the charged electrophoretic particle 100 is to have a negative charge, or the additional monomer may possess a quaternary ammonium group in an example where the charged electrophoretic particle 100 is to have a positive charge. The additional monomers may be added in an appropriate concentration so as to give the particles the desired magnitude of charge. Additional uncharged monomers may be added as well in some examples, for example when the surface is to be modified with a functional group not present in the interior of the particle, as discussed above. The additional monomer or moieties may be added in such a way that the ionizable monomer remains close to the surface of the core structure where its counter ion may be solvated, or may be injected in the bulk of the core structure. In some examples these additional ionizable monomers may have a substantially nonpolar end and a substantially polar end where the ionizable group is located, in which case the monomer possesses surfactant-like qualities, may incorporate itself into the surfactant layer, and may be polymerized and crosslinked into the core structure 102, giving the particle its charge. Such a monomer is referred to as a surfmer.

In some examples, a semi-batch addition of ionizable monomer is not required and may be skipped. For example, a surfmer may have been included in the initial monomer mixture with appropriate concentration and functional groups for the desired charge sign and magnitude. In particular, the surfmer may be near the surface of the core structure. In other examples, a monomer with ionizable groups may be incorporated into the bulk of the core structure, and only the monomer close enough to the surface becomes ionized in polar solvents.

At block 708 the particles are isolated and purified, to concentrate the particles and remove those which do not meet the required specifications. This may be achieved by centrifugation and washing steps, by filtration, by free-flow electrophoresis, by precipitation in other solvents, or by other means.

In some examples, functional groups present on the surface of the particle may be modified at block 710, adding or subtracting a moiety from the particle to produce a charged functional group on the surface of the core structure. That is, charge may be imparted to the core structure via a chemical modification of the core structure which produces charge imparting moieties on the surface of the core structure.

In still other examples, no ionizable monomers may be added in any of the steps of method 700, and the charge will be added during the addition of the polymer arms 104, as discussed below.

At 712 the method is ended, and additional processing steps may be carried out on the resulting core structures as described elsewhere in this disclosure.

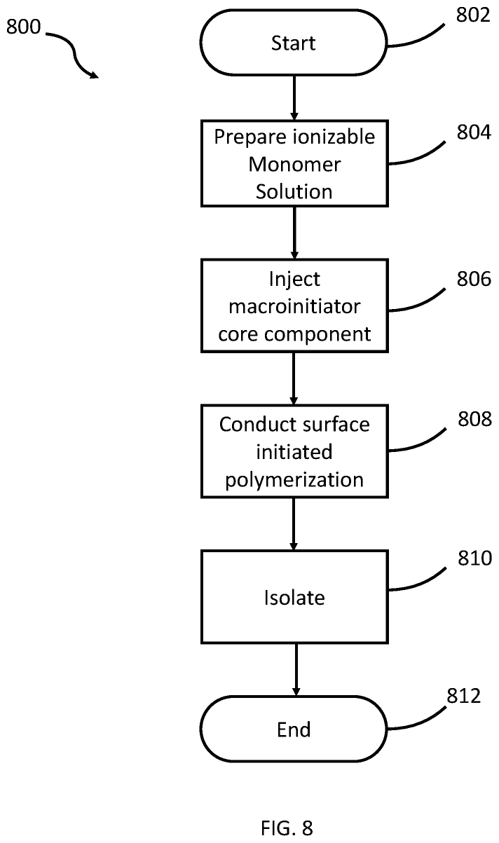

FIG. 8 is a flowchart of an example method 800 of adding a charged polymeric corona including the polymeric arms 104 to a core structure. The method 800 is substantially similar to method 600, but is used in examples where the core structure 102 does not bear ionizable groups and hence may not be charged using the method 700. The method begins at block 802.

At block 804, a monomer solution is prepared which may comprise monomer, solvent, initiator, as well as polymerization mediators. In particular, in some examples, at least one of the monomers may possess an ionizable group. This monomer is included at an appropriate concentration to provide the correct magnitude of charge to the particle. The functional group on the monomer is selected to provide the desired charge sign to the particle. Monomers may be selected to promote the solubility of the final particle 100 in the target solvent in which it is to be dissolved. For example, if the particle 100 is to be dissolved in water or DMSO, a monomer such as acrylamide or glycidyl monomethacrylate may be chosen.

At block 806, macroinitiator core structures are added to the monomer solution. These macroinitiator core structures may have been modified with functional groups or other moieties present on their surfaces which may be able to initiate a polymerization. For example, a core structure with hydroxyl groups such as on a silica sphere, or a polymeric sphere which presents hydroxyl groups on the surface on the surface may be modified with a reagent such as 2-Bromo-2-methylpropionyl bromide, which reacts with the alcohol, leaving an ATRP initiator on the surface. Other reactions are contemplated which functionalize the core structure surface with suitable moieties to be used in other types of polymerization for example nitroxide mediated polymerization or reversible addition fragmentation transfer polymerization.

At block 808, the functionality on the surface of the macroinitiator core structures and the monomer solution participate in a polymerization reaction, in which linear polymer chains are grown from the surface of the macroinitiator core structure. These form the polymer arms 104, akin to the polymer arms which made up the polymeric corona 534 discussed above. This method may be preferable to grafting-to methods in some examples to achieve higher grafting densities of polymer arms on the surfaces of the core structures.

In other examples, the core may have been formed with a polymerization mechanism matching the method which is to be used to grow the polymeric arms. For example, an ATRP mediated microemulsion polymerization may have been carried out with a high concentration of ATRP initiators. As the polymerization proceeds, these initiators may still find themselves present on or near the surface of the core structure after polymerization has ceased. If they are sufficiently close to the surface, within a narrow diffusion layer, these polymer chain ends may be re-initiated in a new ATRP reaction which then proceeds to grow the polymer arm 104 from the surface of the particle.

In some examples, the grown polymer arms may be block copolymers or gradient copolymers comprising at least two monomers to improve the solubility or other properties of the grown polymer arms. The growth of block copolymers may require an additional isolation step to ensure that the monomer from the first block is completely removed from solution before growing the next block. In some examples, it may be preferable for the ionizable monomers to be located close to the core structure 102, in which case at least one ionizable monomer would be comprise the first block. In some examples the first block may also comprise at least one additional uncharged monomer. Additional blocks may be added on which comprise only uncharged monomer. In other examples, a small amount of monomer solution which includes at least one charged monomer may be added at the performance of block 804. After enough time has passed such that most of the monomer solution has been used up in the polymerization, additional uncharged monomer may be added to continue the growth of the polymer arms 104. This may be done to localize the charged monomer to a region close to the core structure 102, which may be preferable in some cases.

Thus, as will be appreciated, in some examples, charge imparting moieties may be born on the polymeric corona close to the surface of the core structure, while in other examples, the polymeric corona may bear charge imparting moieties throughout the polymer corona. In particular, the moieties may be charge imparting monomers in the polymeric corona near the core structure or throughout the polymeric corona.

At block 810 the particles are isolated and purified, to concentrate the particles and remove those which do not meet the required specifications. This may be achieved by centrifugation and washing steps, by filtration, by free-flow electrophoresis, by precipitation in other solvents, or by other means.

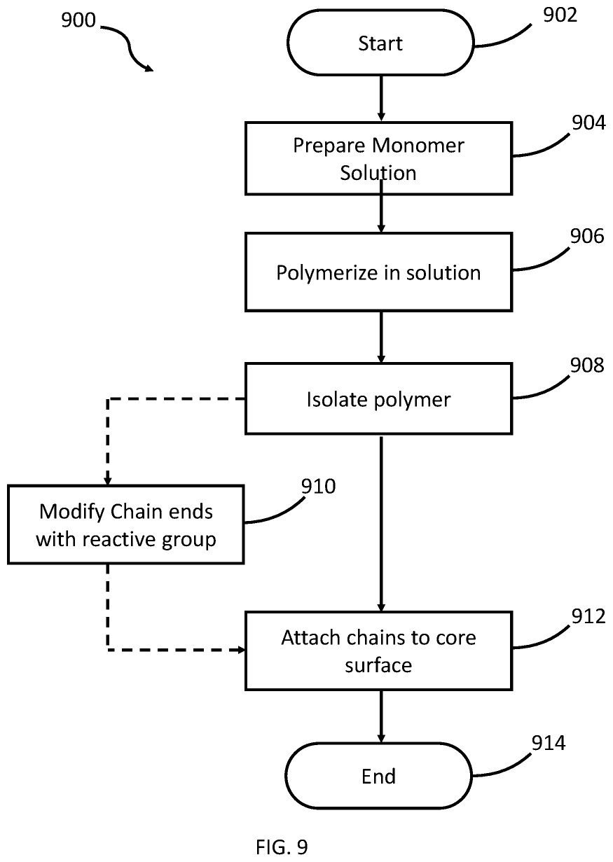

FIG. 9 is a flowchart of an example method 900 of adding a charged polymeric corona including the polymeric arms 104 to a core structure. The method 900 is substantially similar to method 500, but is used in examples where the core structure 102 does not bear ionizable groups and hence may not be charged using the method 700. The method begins at block 902.

At step 904 a monomer solution is prepared which may comprise monomer, solvent, initiator, as well as polymerization mediators. In particular, in some examples, at least one of the monomers may possess an ionizable group. This monomer is included at an appropriate concentration to provide the correct magnitude of charge to the particle. The functional group on the monomer is selected to provide the desired charge sign to the particle. Monomers may be selected to promote the solubility of the final particle 100 in the target solvent in which it is to be dissolved. For example, if the particle 100 is to be dissolved in water or DMSO, a monomer such as acrylamide or glycidyl monomethacrylate may be chosen.

In some examples, the linear polymer chains may be block copolymers or gradient copolymers comprising at least two monomers to improve the solubility or other properties of the linear polymer chains. The growth of block copolymers may require an additional isolation step to ensure that the monomer from the first block is completely removed from solution before growing the next block.

Thus, as will be appreciated, in some examples, charge imparting moieties may be born on the polymeric corona close to the surface of the core structure, while in other examples, the polymeric corona may bear charge imparting moieties throughout the polymer corona. In particular, the moieties may be charge imparting monomers in the polymeric corona near the core structure or throughout the polymeric corona.

At block 908, the produced linear polymer is isolated, whether by precipitation in a nonsolvent or other method.

Block 910 is an optional step in which the ends of the obtained linear polymer are modified with a reactive group that permit chemical linking to other reactive groups. Depending on the polymerization method used, this step may be superfluous. For example, if the polymerization method chosen was a variety of ATRP, an ATRP initiator may have been selected which already presented a reactive functional group, such as in the case of 2-Azidoethyl 2-bromoisobutyrate or 3-Butynyl 2-bromoisobutyrate for example. The performance of block 910 for example may entail positioning a strong nucleophile or electrophile on either end of the linear polymer using whichever reactive groups are known to be present on them. It may also entail positioning some other terminal coupling agent which may be used in an organometallic coupling reaction.

At block 912, the obtained linear polymer may be attached to the surface of the core structure 102.

The core structure 102 may be formed by any of the above mechanisms. As described above, the core structure 102 may comprise a polymer or other dielectric material, or an outer polymer layer which has reactive functional groups present on the surface. These functional groups may be used as provided to link to functional groups on the linear polymer obtained at block 906. In other examples they may be used to link to another compound which presents a linking group which is specifically chosen to be linked to the group provided at the end of the linear polymer.

In some examples, it may be preferable to add charged functional groups to the core structure, either by the method 700, or by using a charged multifunctional core in method 400, as opposed to the polymeric corona as in methods 800 and 900 to give better electrostatic characteristics of the particles. Having the charged functional groups separated by the polymeric corona may make it easier for an electric field to separate oppositely charged particles, as the distance between the charges may be increased, which leads to smaller electrostatic forces between the particles. In other embodiments, it may be preferable to have higher electrostatic forces, to increase the rate of color change, in which case it may be preferable to locate the charged functional groups within the polymeric corona. This may be the case when the device needs a high contrast between colored and uncolored states, and when the device's power consumption is not of primary concern as it would be with a mobile device.

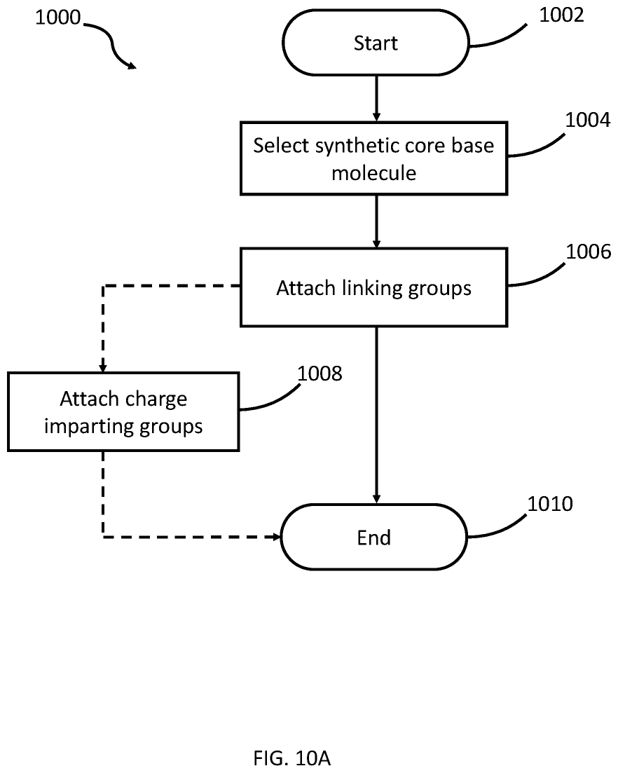

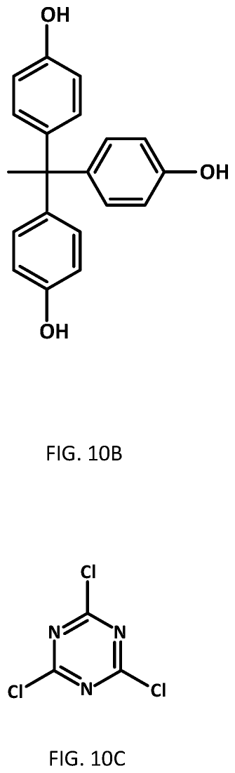

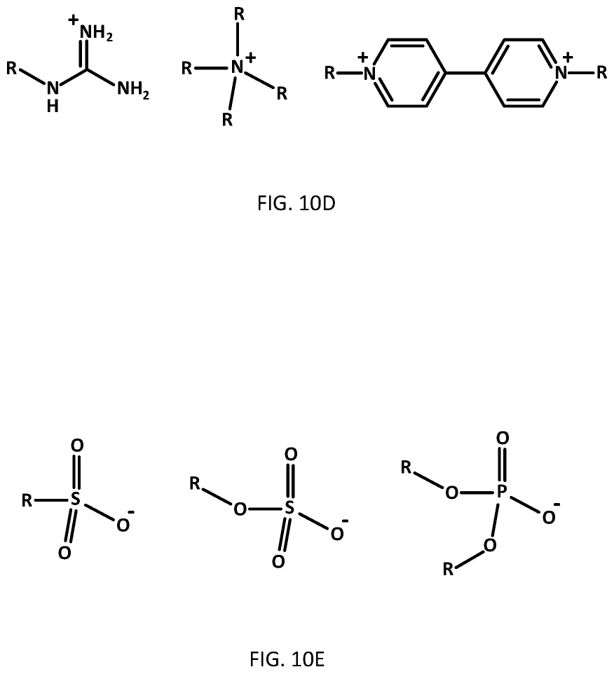

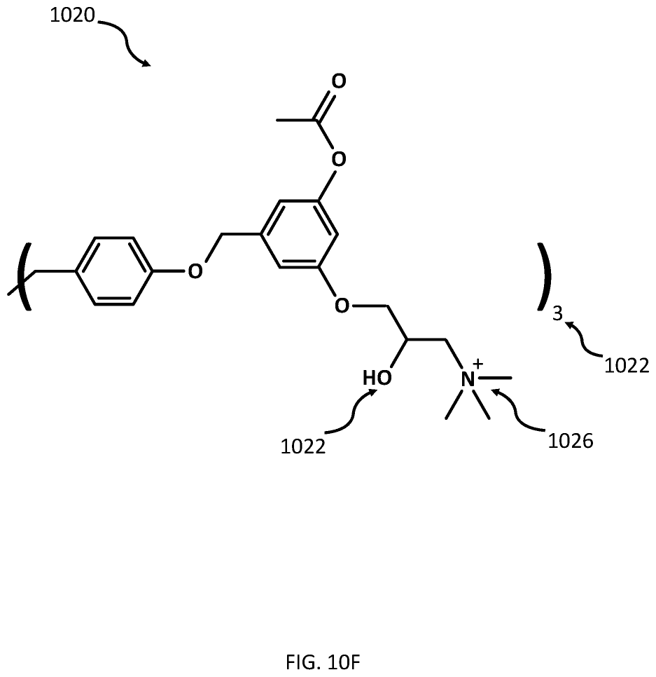

Turning now to FIG. 10A, a flowchart of an example method 1000 for obtaining a multifunctional synthetic core for use in the synthesis of dendrimer-based core structures. At block 1002 the method is begun.

At block 1004, a synthetic core base molecule is selected. This molecule may have at least one functional group which may be used to attach additional moieties. In some examples it may be preferable to select a synthetic core base molecule which has a number of functional groups equal to the maximum of either the number of charges required on the desired number of initial linking functional groups. In other examples a different number of functional groups may be selected.

At block 1006, the linking groups may be added to the synthetic core base molecule.

At block 1008, charge imparting groups may be added to the synthetic core base molecule. In some examples, charge imparting groups will be added at a later stage as discussed above and block 1008 may be omitted.

In some examples, block 1008 and block 1006 are performed simultaneously. In other examples they are performed in reverse order. In still other examples, both blocks may be omitted if the synthetic core base molecule already possesses the required linking groups and charge imparting groups required for the dendrimer molecule.

Turning now to FIG. 10B, a chemical diagram of an example trifunctional synthetic core base molecule is depicted, which is referred to as 1,1,1-tris(4′-hydroxyphenyl)ethane or as THPE. This molecule possesses 3 hydroxy groups which can be used as nucleophiles to attach linking groups and charge imparting groups. Each hydroxy group is symmetrical and does not generally affect the reactivity of the other groups substantially, meaning that under most reaction conditions, a reaction carried out on one of the hydroxy groups will be carried out on all 3, provided at least 3 equivalents of the reactant were reacted.

FIG. 10C depicts a chemical diagram of an example trifunctional synthetic core base molecule, which is referred to as cyanuric chloride. In this example, the carbons to which the chlorine atoms are bonded are electrophiles which may be used to attach linking groups and charge imparting groups. In this example the sites exhibit a substantially different reactivity depending on how many of the sites have been substituted, and by carefully controlling reaction conditions a different substituent can be put on each site. Not all sites may be substituted.

FIGS. 10B and 10C both feature trifunctional synthetic core base molecules, which may be preferable in some examples. In other examples, a different functionality number may be desired.

FIGS. 10D and 10E depict chemical diagrams of example positively charged and negatively charged charge imparting groups, respectively. Charge imparting groups may preferably be selected based on their good chemical stability under the reaction conditions of the dendrimer synthesis process, as well as for their strong tendency not to deionize in some solvents, as might happen with weak acids or bases such as carboxylic acids or amines for example. Listed left to right, top to bottom, the example charge imparting groups provided are guanidine, quaternary ammonium, viologen (which bears two positive formal charges), sulfonate, organosulfate, and organophosphate.

FIG. 10F depicts a chemical diagram of an example positively charged multifunctional synthetic core 1020 which is based on THPE from FIG. 10B. Multifunctional synthetic core 1020 has three identical branches as indicated by symbol 1022. Multifunctional synthetic core 1020 comprises three hydroxy linking groups which may be used to link to the first generation, as well as three quaternary ammonium groups to give it a charge of positive three fundamental charges.

Multifunctional synthetic core 1020 is an example of a molecule with three linking groups and three positive charges, but different numbers of each may be chosen, and negative charges may be used, as discussed above. The selection depends on the application, as well as desired size and brush density of the dendrimer-based charged electrophoretic particle.

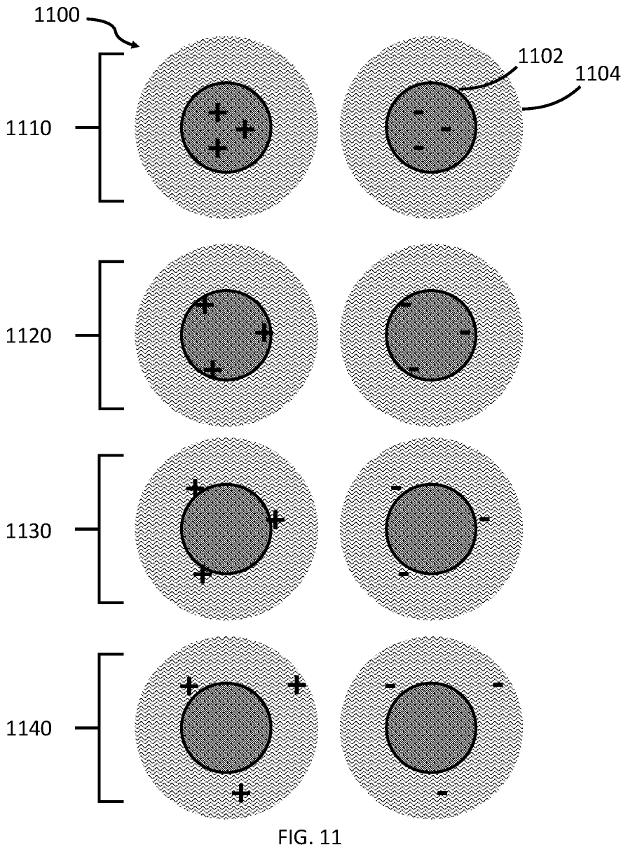

Turning now to FIG. 11, which depicts a schematic diagram of examples of the different locations the charge may be located in the charged electrophoretic particles 1100, comprising core structures 1102 and polymeric corona 1104.

The pair of within-core-charged particles 1110 depict the positive and negative charges located within the core of the core structure 1102, as may be obtained in an example using an ionizable monomer within the bulk of the core structure 1102 during the polymerization reaction, especially when the core structure is substantially comprised of a water-soluble monomer.

The pair of surface core-charged particles 1120 depict the positive and negative charges located on the surface of the core structure 1102, as may be obtained in an example by functionalizing the surface of the core structure 1102 with an ionizable group, or by using a surfmer in the production of the core structure 1102.

The pair of centrally arm-charged particles 1130 depict the positive and negative charges located within the polymeric coronae 1104 close to the base of the polymer arms such that the charge is close to the core structure 1102, as may be obtained in an example by growing a gradient or block copolymer from the surface of the core structure 1102 or by grafting on a gradient or block copolymer to the surface of the core structure 1102.

The pair of distributed arm-charged particles 1140 depict the positive and negative charges located within the polymeric coronae 1104 distributed throughout the polymeric coronae 1104 not necessarily close to the core structure 1102, as may be obtained in an example by growing a random or block copolymer from the surface of the core structure 1102 or by grafting on a random or block copolymer to the surface of the core structure 1102.

The scope of the claims should not be limited by the embodiments set forth in the above examples, but should be given the broadest interpretation consistent with the description as a whole.

1. A charged electrophoretic particle comprising:
a dielectric core structure; and
a polymeric corona surrounding the core structure, the polymeric corona comprising:
several polymer arms; and
a first chemical entity inducible to reversibly switch between a separated state, relative to a second chemical entity, and an optically active state, with the second chemical entity, to change an optical property of the electrophoretic particle in response to the second chemical entity.

2. The charged electrophoretic particle of claim 1 wherein the core structure bears charge imparting moieties in a bulk of the core structure.

3. The charged electrophoretic particle of claim 2 wherein the charge is imparted by charge imparting monomers in a bulk of the core structure.

4. The charged electrophoretic particle of claim 1 wherein the core structure bears charge imparting moieties at a surface of the core structure.

5. The charged electrophoretic particle of claim 4 wherein the charge is imparted by charge imparting surfmers near a surface of the core structure.

6. The charged electrophoretic particle of claim 4 wherein the charge is imparted by charge imparting monomers near a surface of the core structure.

7. The charged electrophoretic particle of claim 4 wherein the charge is imparted by a chemical modification of the core structure which produces charge imparting moieties on the surface.

8. The charged electrophoretic particle of claim 1 wherein the polymeric corona bears charge imparting moieties close to the surface of the core structure.

9. The charged electrophoretic particle of claim 8 wherein the charge is imparted by charge imparting monomers in the polymeric corona near the core structure.

10. The charged electrophoretic particle of claim 1 wherein the polymeric corona bears charge imparting moieties throughout the polymer corona.

11. The charged electrophoretic particle of claim 10 wherein the charge is imparted by charge imparting monomers in the polymeric corona throughout the polymeric corona.

12. The charged electrophoretic particle of claim 1 wherein the core structure is made with an emulsion polymerization method.

13. The charged electrophoretic particle of claim 1 wherein the core structure is made with an microemulsion polymerization method.

14. The charged electrophoretic particle of claim 1 wherein the core structure is made with a dispersion polymerization method.

15. The charged electrophoretic particle of claim 1 wherein the core structure is made with a Stober process method.

16. The charged electrophoretic particle of claim 1 wherein the core structure is made with a dendrimer synthesis method.

17. The charged electrophoretic particle of claim 1 wherein the polymeric corona is formed by grafting polymer arms to the core structure.

18. The charged electrophoretic particle of claim 1 wherein the polymeric corona is formed by growing polymer arms from the core structure.

19. The charged electrophoretic particle of claim 1 wherein the charge is imparted by charge imparting moieties in a multifunctional synthetic core of a dendrimer.

20. A method of forming a charged electrophoretic particle, the method comprising:
forming an uncharged core structure;
charging the core structure; and
adding an uncharged polymeric corona to the charged core structure, the polymeric corona including several polymer arms and a first chemical entity inducible to reversibly switch between a separated state, relative to a second chemical entity, and an optically active state, with the second chemical entity, to change an optical property of the electrophoretic particle in response to the second chemical entity.

21. The method of claim 20, wherein forming the uncharged core structure comprises applying a microemulsion polymerization method.

22. The method of claim 20, wherein forming the uncharged core structure comprises applying an emulsion polymerization method.

23. The method of claim 20, wherein forming the uncharged core structure comprises applying a dispersion polymerization method.

24. The method of claim 20, wherein forming the uncharged core structure comprises applying a Stober process method.

25. The method of claim 20, wherein charging the core structure comprises injecting charge imparting moieties into a bulk of the core structure.

26. The method of claim 20, wherein charging the core structure comprises injecting charge imparting monomers into a bulk of the core structure.

27. The method of claim 20, wherein charging the core structure comprises injecting charge imparting moieties near a surface of the core structure.

28. The method of claim 20, wherein charging the core structure comprises injecting charge imparting monomers near a surface of the core structure.

29. The method of claim 20, wherein adding the uncharged polymeric corona comprises:
preparing a monomer solution including at least one monomer, at least one initiator and at least one solvent;
polymerizing the monomer solution to grow a linear polymer; and
attaching the linear polymer to the charged core structure.

30. The method of claim 20, wherein adding the uncharged polymeric corona comprises:
preparing a monomer solution including at least one monomer, at least one initiator and at least one solvent;
modifying the core structure to include moieties on a surface of the core structure, the moieties to initiate polymerization; and
polymerizing the monomer solution to grow linear polymers from the moieties.

31. A method of forming a charged electrophoretic particle, the method comprising:
forming an uncharged core structure; and
adding a charged polymeric corona to the uncharged core structure, the charged polymeric corona including several polymer arms and a first chemical entity inducible to reversibly switch between a separated state, relative to a second chemical entity, and an optically active state, with the second chemical entity, to change an optical property of the electrophoretic particle in response to the second chemical entity.

32. The method of claim 31, wherein forming the uncharged core structure comprises applying a microemulsion polymerization method.

33. The method of claim 31, wherein forming the uncharged core structure comprises applying an emulsion polymerization method.

34. The method of claim 31, wherein forming the uncharged core structure comprises applying a dispersion polymerization method.

35. The method of claim 31, wherein forming the uncharged core structure comprises applying a Stober process method.

36. The method of claim 31, wherein adding the charged polymeric corona comprises:
preparing a charged monomer solution including at least one charged monomer, at least one initiator and at least one solvent;
polymerizing the charged monomer solution to grow a linear polymer; and
attaching the linear polymer to the charged core structure.

37. The method of claim 36, further comprising adding an uncharged monomer solution to continue to grow the linear polymer to localize the charged monomer close to the core structure.

38. The method of claim 31, wherein adding the uncharged polymeric corona comprises:
preparing a charged monomer solution including at least one charged monomer, at least one initiator and at least one solvent;
modifying the core structure to include moieties on a surface of the core structure, the moieties to initiate polymerization; and
polymerizing the monomer solution to grow linear polymers from the moieties.

39. The method of claim 38, further comprising adding an uncharged monomer solution to continue to grow the linear polymer to localize the charged monomer close to the core structure.

40. A method of forming a charged electrophoretic particle, the method comprising:
forming a charged dendrimer core structure; and
adding an uncharged polymeric corona to the charged dendrimer core structure, the polymeric corona including several polymer arms and a first chemical entity inducible to reversibly switch between a separated state, relative to a second chemical entity, and an optically active state, with the second chemical entity, to change an optical property of the electrophoretic particle in response to the second chemical entity.

41. The method of claim 40, wherein adding the uncharged polymeric corona comprises:
preparing a monomer solution including at least one monomer, at least one initiator and at least one solvent;
polymerizing the monomer solution to grow a linear polymer; and
attaching the linear polymer to the charged dendrimer core structure.

42. The method of claim 40, wherein adding the uncharged polymeric corona comprises:
preparing a monomer solution including at least one monomer, at least one initiator and at least one solvent;
modifying the core structure to include moieties on a surface of the core structure, the moieties to initiate polymerization; and
polymerizing the monomer solution to grow linear polymers from the moieties.
